(19) United States
(12) Patent Application Publication
(10) Pub. No.: US 2015/0266144 A1
(43) Pub. Date: Sep. 24, 2015

(54) Method for Manufacturing a Heat Exchanger Containing a Phase-Change Material, Exchanger Obtained and Uses at High Temperatures

(71) Applicant: COMMISSARIAT A L'ENERGIE ATOMIQUE ET AUX ENERGIES ALTERNATIVES, Paris (FR)

(72) Inventors: Alain Bengaouer, Crolles (FR); Guilhem Roux, Saint-Egreve (FR)

(73) Assignee: COMMISSARIAT A L'ENERGIE ATOMIQUE ET AUX ENERGIES ALTERNATIVES, Paris (FR)

(21) Appl. No.: 14/434,363

(22) PCT Filed: Oct. 7, 2013
(86) PCT No.: PCT/IB2013/059175

§ 371 Date: Apr. 8, 2015

(30) Foreign Application Priority Data
Oct. 9, 2012 (FR) 1259604

(51) Int. Cl. B23P 15/26; F28D 20/02

(52) U.S. Cl. CPC B23P 15/26; F28D 20/02

(57) ABSTRACT

The invention relates to a heat-exchanger module (1) comprising at least one fluid circuit comprising at least one fluid-circulation channel (13), at least one cell containing a phase-change material (PCM) such as a metal alloy or salt, at least the cell(s) being defined by walls (10) of at least one first metal plate (10.1, 10.2, 10.3) which can be welded, diffusion welded or brazed onto a second metal plate (10.1, 10.2, 10.3). The invention relates to the related manufacturing methods as well as to the uses at high temperatures.

### TECHNICAL FIELD

The present invention relates to a process for producing a heat exchanger module comprising at least one fluid circuit comprising at least one fluid circulation channel, at least one cell containing a phase-change material (PCM). A heat exchanger module according to the invention may comprise at least one outer face intended to be in contact with a heat flux originating from a surrounding medium.

An exchanger obtained according to the process of the invention makes it possible, owing to the phase-change material that it incorporates, to store heat or to smooth out temperature fluctuations of systems.

The applications targeted by an exchanger according to the invention are numerous and relate to the processes in which the heat exchanges are carried out at high temperatures. For the purposes of the invention, the expression “high temperatures” is understood to mean temperatures above 200° C., preferably between 400 and 800° C.

More particularly, for heat storage, an exchanger according to the invention may store energy for a later use. For example, an exchanger according to the invention may store heat produced by a solar receiver during the day for use in the evening or overnight for heating purposes, or else recover the heat lost cyclically by an industrial (foundry, steel works) process in order to supply another process.

More particularly, for smoothing out temperature fluctuations, a heat exchanger according to the invention may guarantee the operating temperature of a system and thus ensure the safety thereof or increase the service life thereof. For example, an exchanger according to the invention may protect the components of a concentrating solar power plant against variations in insolation (passage of clouds), microelectronic components against overheating or else may limit thermal excursions in batteries.

Known heat exchangers comprise one or at least two circuits with internal fluid circulation channels. In the exchangers with a single circuit, the heat exchanges take place between the circuit and a surrounding fluid in which it is immersed. In the exchangers with at least two fluid circuits, the heat exchanges take place between the two fluid circuits.

Chemical reactors are known which carry out a continuous process according to which a small amount of co-reactants is injected simultaneously, in the presence or absence of catalysts, at the inlet of a first fluid circuit, preferably equipped with a mixer, and the chemical obtained at the outlet of said first circuit is recovered. Among these known chemical reactors, some comprise a second fluid circuit, usually referred to as a utility, the role of which is to thermally control the chemical reaction, either by providing the heat needed for the reaction, or on the contrary by removing the heat given off thereby. Such chemical reactors having two fluid circuits with utility are usually referred to as exchanger-reactors.

Heat exchangers that contain a phase-change material are known, as described in detail below. In general they comprise a single fluid circuit with a plurality of fluid circulation channels, and a plurality of cells containing a phase-change material (PCM), in which each channel is adjacent to a cell. Exchangers that use a plurality of fluid channels but a single cell containing a PCM material also exist.

The present invention relates equally to the production of heat exchangers having at least one fluid circuit that carries out the heat exchange between several fluids, a heat absorber ensuring the transmission of a flux from the outer surface to a fluid or an exchanger-reactor in which a chemical reaction takes place in one of the channels while another channel or several other channels have the role of controlling the temperature.

Therefore, the expression “heat exchanger” should be understood within the context of the invention to mean both an exchanger-reactor and a heat exchanger containing a phase-change material having heat exchange and/or storage and/or recovery functions.

### PRIOR ART

It is known that phase-change materials (PCM) are materials capable of exhibiting a reversible physical phase change, the associated enthalpy (or latent heat) variation of which enables thermal energy to be stored and released. In terms of volume density, the storage capacity of a PCM material is typically 3 to 4 times greater than that which it is possible to achieve via the sensible heat. The phase change of a PCM material is of an isothermal nature, i.e. it takes place at constant temperature. Thus, for example, by way of reference, the latent heat of fusion of copper is 13.3 kJ/mol for a heat capacity of 24.5 J/mol/K, i.e. a temperature difference of more than 500° C. is needed in order to store by sensible heat the same energy as by latent heat: [1].

There are four types of phase change for PCM materials, respectively solid-solid, solid-liquid, solid-vapor and liquid-vapor. The latent heat and the volume change of a PCM material are even higher when the change of order (given by the entropy change) associated with the phase transition is high. Thus, for example, a solid-vapor change of order is greater than a solid-liquid change of order which is itself greater than a solid-solid change of order. The liquid-vapor phase change is accompanied by a very large increase in volume, whereas the solid-solid phase change has the advantage of causing small volume changes, but offers quite a low latent heat, typically of a few tens of kJ/kg. The liquid-solid phase change offers a high latent heat of phase change, typically of a few hundreds of kJ/kg for a moderate volume change.

There are several families of PCM materials ranging from simple materials to compound materials: reference may in particular be made to FIG. 2 of publication [2]. Among the simple materials, a distinction is conventionally made between organic materials and inorganic materials. Among the compound materials, a distinction is made between eutectic compounds of organic-organic, organic-inorganic and inorganic-inorganic types. These families of PCM materials may also be classified according to the chemical nature of the materials: paraffins, fatty acids, salt hydrates, nitrates, etc. Reference may be made to publication [2] which illustrates a classification of families of PCM materials as a function of their volume density of heat storage.

In practice, it is known to select a PCM material as a function of the operating temperature of a system for which the material is intended.

However, the latent heat is not the only criteria for utilizing phase-change materials (PCMs), as indicated by the authors of publication [2]: the latter specify that, generally, the choice of a PCM material may be made by taking into account various criteria that may be listed as follows:
thermodynamics: a suitable phase change temperature, a high latent heat, a high thermal conductivity and a high thermal diffusivity;
intrinsic physical properties: high density, small volume change, reproducibility and stability in cycling;
chemical properties: long-term chemical stability, compatibility with the other materials of the system, reversibility of the phase change, absence of chemical decomposition, non-toxicity, non-flammability, non-explosivity,
absence of subsaturation, no supercooling, absence of segregation;
economics: abundance, availability, low-cost, recyclability.

The choice of PCMs that enable heat storage is broad and the literature proposes several review articles for these choices: reference may be made to publications [2], [3] and [4].

In the temperature ranges which may be of concern to processes operating at high temperatures, such as solar storage, and processes for reforming or utilizing high-temperature heat, the PCM materials mainly used are molten salts and metallic materials.

Molten salts are generally characterized by a very high latent heat and a low or even very low conductivity. For example, lithium salts (LiOH) have a latent heat of liquid-solid phase change of the order of 875 kJ/kg but have a conductivity of the order of 1 W/m/K. The use of these materials in particular involves efficient management of the heat fluxes by a specific design of the containment cells thereof and of the elements constituting the envelope, and a good control of the corrosion resistance of the envelopes: reference may be made to publication [5]. It is furthermore suggested in this publication that the large increase in volume during melting, typically 1% to 30%, the supercooling and the cost are limitations to the use of molten salts.

Metallic materials, despite a latent heat generally lower than that of molten salts, form an alternative to the latter. Thus, the authors of publication [6] identify the Al—Cu, Al—Si, Al—Cu—Mg and Al—Si—Mg metal alloys as suitable for processes using the combustion of fossil fuels and the Mg₂Si—Si alloy for solar applications. The authors of publication [7] themselves propose new ternary metal alloys for applications in which the temperatures are between 430° C. and 730° C.

As regards the manufacture of envelopes intended to contain PCM materials, the cells of these envelopes must have a low chemical reactivity with respect to the PCM material, so as to guarantee the containment thereof and the integrity of the envelopes.

A distinction may be made between the structure of said envelopes as a function of the dimensions of the PCM materials.

For small dimensions, generally of the order of a millimeter, the envelopes form what may be denoted by microencapsulations of the PCM and are used in a fixed bed, in a fluidized bed or in suspension, as described in publication [1] and U.S. Pat. No. 4,873,038.

Patent application WO 2010/034954 discloses a process for manufacturing an agglomerate of microcapsules of PCM that is applied to gas separation processes, the PCM having the role of limiting the temperature fluctuations that limit the efficiency of the processes.

Patent application WO 2010/146197 describes a composite material formed from a carbon structure partially filled with an LiOH/KOH mixture as PCM material. The low thermal conductivity of the LiOH/KOH mixture is compensated for by the high thermal conductivity of the carbon. The targeted phase change temperatures range from 225° C. to 488° C. depending on the chosen compositions of each of the two components of the LiOH/KOH mixture.

For larger dimensions, generally of the order of a centimeter to about ten centimeters, the envelopes form what may be denoted by macroencapsulations of the PCM. The design of these macroencapsulation envelopes must then guarantee a storage capacity suitable for the requirement and a sufficient heat exchange capacity with the heat transfer fluid or the surface exposed to the flux in the case of a surface exchange. As indicated above, when the PCMs are salts, their low conductivity imposes a specific design of their containment cells and of the elements constituting the envelope, either with fins, or with honeycombs, or with foams or any other device that promotes heat exchange: for further details reference may be made to publications [5], [8]. When the PCMs are metals, the thermal conductivity is no longer as limiting a factor and containment cells of larger dimensions may be used: for further details reference may be made to publications [9], [10].

Various documents describe the production of a heat exchanger comprising at least one fluid circuit with fluid circulation channels, cells containing a PCM material, in which each channel is adjacent to at least one cell.

U.S. Pat. No. 7,718,246 discloses a partially porous honeycomb structure incorporating PCM containment cells and exchange fluid circulation channels adjacent to the cells.

U.S. Pat. No. 4,124,018 describes a solar receiver coupled to an exchanger containing a PCM material, somewhat dedicated to relatively low-temperature applications. A process for producing the exchanger is described: it consists in assembling, via diffusion welding, a series of flat plates, a portion of the surface of which is masked, then the assembled exchanger is pressurized so as to form the fluid circulation channels and the containment cells of the PCM are formed. Next, the cells formed are filled with a molten PCM via ports while the air contained in the cells is evacuated via vents. The ports and the vents are then rendered leaktight. The manufacturing technique described in this U.S. Pat. No. 4,124,018 requires thin wall thicknesses, which results in a low mechanical strength of the exchanger and therefore limits the field of application thereof. The use of such an exchanger cannot thus be envisaged at high pressures and/or high temperatures.

Patent DE102010004358 discloses a ceramic honeycomb exchanger structure obtained by an extrusion technique, which enables the storage of PCM (salt or metal) having a high melting point, typically above 800° C. While the very small size of the fluid circulation channels and of the PCM cells, typically of less than 2 mm, makes it possible to obtain good heat exchanges, on the other hand the shapes capable of being obtained by the extrusion technique are limited. Indeed, the channels obtained by extrusion may only be rectilinear. This shape limitation excludes the use of these techniques for exchangers in which the curvature of the channels is essential for ensuring the mixing of reactants and the heat exchanges.

To the knowledge of the inventors, no prior art exists which describes the production of heat exchangers comprising at least one fluid circuit with fluid circulation channels, cells containing a PCM material of metal or salt type, in which each channel is adjacent to at least one cell and which makes it possible to obtain cell dimensions and shapes that can be adapted on demand, typically between 5 and 500 mm and this being in order to obtain a large volumes storage capacity and a high rate of heating/heat recovery.

Furthermore, it is known to produce existing heat exchangers, referred to as plate heat exchangers, that do not contain PCM materials according to various techniques.

The circulation channels of these exchangers may be produced by drawing plates, where appropriate by adding strips bent in the form of fins or by machining grooves. The machining may be carried out by mechanical means, for example by milling or by chemical means. Chemical machining is usually referred to as chemical or electrochemical etching.

The objective of assembling the plates with one another is to ensure the leaktightness and/or the mechanical strength of the exchangers, in particular the resistance to the pressure of the fluids circulating within.

Several assembly techniques are known and are used depending on the type of plate exchanger desired. The assembly may thus be obtained by mechanical means, such as tie rods that keep the stack clamped between two thick and rigid plates positioned at the end of the stack. The leaktightness of the channels is then obtained by compressing added seals. The assembly may also be obtained by welding, generally limited to the periphery of the plates, which sometimes requires the exchanger to be inserted, subsequent to the welding, in a shell in order to enable its resistance to the pressure of the fluids. The assembly may also be obtained by brazing, in particular for exchangers for which fins are added. The assembly may finally be obtained by diffusion welding.

The latter two techniques mentioned make it possible to produce heat exchangers that perform particularly well in terms of mechanical strength. Indeed, owing to these two techniques, the assembly is obtained not only at the periphery of the plates but also inside the exchanger.

The plate heat exchangers obtained by diffusion welding have joints that perform even better mechanically than the joints of exchangers obtained by brazing due to the very fact of the absence of the filler metal required for the brazing.

Diffusion welding consists in obtaining an assembly in the solid state by applying a hot force to the parts to be assembled for a given time. The force applied has a two-fold function: it enables alignment, i.e. bringing the surfaces to be welded into contact, and it facilitates the removal, by diffusion creep, of the residual porosity in the joints (interfaces).

The force may be applied by uniaxial pressing, for example using a press equipped with a furnace or simply with the aid of weights placed on top of the stack of parts to be assembled. This process is commonly referred to as uniaxial diffusion welding and it is applied industrially for the manufacture of plate heat exchangers.

A significant limitation of the uniaxial diffusion welding process stems from the fact that it does not make it possible to weld joints of any orientation with respect to the direction of application of the uniaxial pressing force.

Another alternative process overcomes this drawback. In this other process, the force is applied by the pressure of a gas using a leaktight container under vacuum. This process is commonly referred to as hot isostatic pressing (HIP). Another advantage of the HIP diffusion welding process compared to the uniaxial diffusion welding process is that it is considerably more common on the industrial scale. Indeed, HIP is also used for the batch treatment of foundry parts and also for powder compaction.

In the HIP diffusion welding process, the stack of the parts is first encapsulated in a leaktight container in order to prevent the gas from penetrating into the interfaces formed by the surfaces to be welded. The gas pressure customarily used is high, of the order of 500 to 2000 bar, typically 1000 bar. The minimum operating pressure of the industrial chambers suitable for carrying out HIP is itself between 40 and 100 bar.

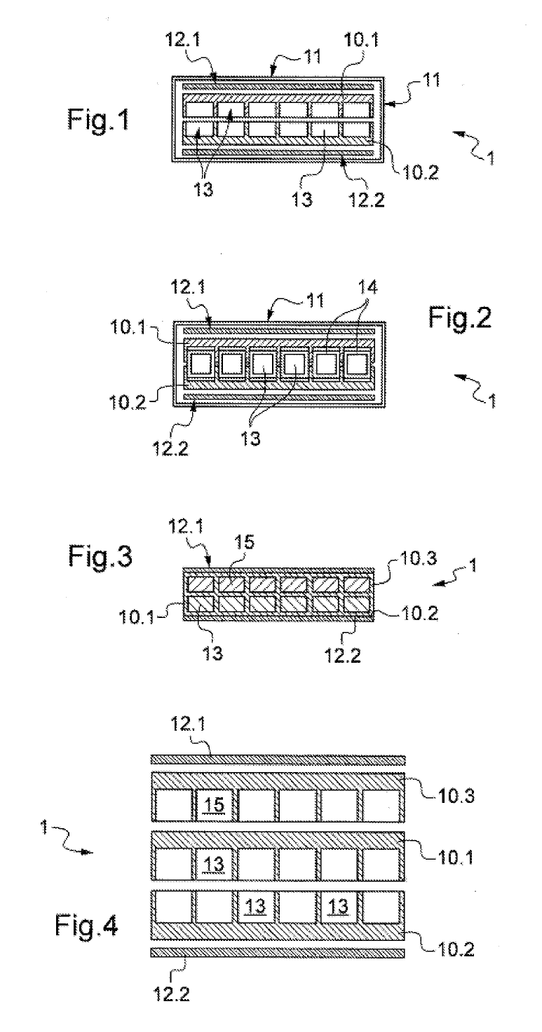

Described with reference to FIG. 1 is the known manufacture of a heat exchanger 1 receiving, on one of its faces, a heat flux originating from a surrounding medium and transmitting it to a heat transfer fluid. Grooves are made in two metal plates 10.1, 10.2 by chemical or mechanical machining. The metal plates 10.1, 10.2 are then cleaned and positioned against one another with their grooves facing in a container 11. Plates 12.1, 12.2 are positioned on either side of the two grooved plates 10.1, 10.2 inside the container 11. Vacuum is then applied inside the container in order to extract therefrom the gases harmful to the welding, then a hot isostatic pressing (HIP) cycle is applied, which makes it possible to obtain the diffusion welding of the plates 10.1, 10.2, 12.1, 12.2. The channels 13 for circulation of the heat transfer fluid are thus formed by the grooves of the plates 10.1, 10.2 themselves, the edges of which are assembled by diffusion welding.

Several solutions are already known for producing heat exchangers by HIP diffusion welding while controlling the geometry of the channels and the quality of the interfaces.

A first known solution consists in using a preformed tube for each channel, and welding at least one end of this preformed tube in a leaktight manner to the container which is itself leaktight. Each tube is first inserted into a groove of a plate and then the tubes inserted into the grooves of one and the same plate are sandwiched with another grooved or non-grooved plate which is adjacent. This known manufacturing solution is described with reference to FIG. 2: preformed tubes 14 are inserted individually into the grooves between the plates 10.1, 10.2. The channels 13 for circulation of the heat transfer fluid are thus formed by the tubes 14 and delimited by the grooves of the plates 10.1, 10.2 assembled therewith by diffusion welding.

A second known solution is described in patent application WO 2006/067349. It essentially consists in preventing the interfaces to be welded from opening into the channels. Thus, the solution according to this patent application consists in producing, in metal plates, grooves having an open cross section at the tops thereof, then in sealing these tops individually by welding a thin metal strip, while thus leaving one or both end(s) of the grooves accessible to the pressurizing gas.

A third known solution WO 2011/036207 consists in producing a hollow area in a plate with a fusible member, in stacking it between two solid plates, then carrying out a HIP cycle by varying the temperature and pressure conditions in order to obtain, firstly, an initial diffusion welding between plates without penetration of the pressurizing gas within the hollow area and then, secondly, melting of the fusible member thus enabling the gas to penetrate within the hollow area and complete the diffusion welding.

The general objective of the invention is to propose a process for producing heat exchangers comprising at least one fluid circuit with at least one fluid circulation channel, at least one cell containing a PCM material of metal or salt type, in which each channel is adjacent to at least one cell and which makes it possible to obtain cell dimensions and shapes that can be adapted on demand, typically between 2 and 250 mm and this being in order to obtain a large volume storage capacity and a high rate of thermal heating, where appropriate by recovery.

### SUMMARY OF THE INVENTION

In order to do this, one subject of the invention is, according to a first alternative, a process for producing a heat exchanger module comprising at least one fluid circuit of elongated shape along an axis X and comprising at least one fluid circulation channel, at least one cell containing a phase-change material (PCM), wherein each channel is adjacent to at least one cell.

According to this first alternative of the invention, the process comprises the following steps:

a/ machining at least one groove in a metal plate, the groove being open at at least one of its ends;

b/ positioning another metal plate against the machined plate so that at least one groove of the machined plate delimits a portion of a cell;

c/ assembling the metal plates with one another, either by hot isostatic pressing (HIP), or by hot uniaxial pressing (HUP) so as to obtain diffusion welding between the metal plates, or by brazing, at least one groove of the machined plate assembled with the other plate delimiting a cell that is open at at least one of its ends;

d/ filling each cell with a phase-change material (PCM) of metal alloy or salt type, either by pouring the PCM material in the liquid state or by inserting the PCM material in the solid state;

e/ positioning another metal plate, referred to as a closure plate, against the already assembled plates so as to close each open end of each cell filled with PCM material;

f/ assembling the closure plate with the already assembled plates either by welding or by brazing.

Another subject of the invention is, according to a second alternative, a process for producing a heat exchanger module comprising at least one fluid circuit and comprising at least one fluid circulation channel, at least one cell containing a phase-change material (PCM), wherein each channel is adjacent to at least one cell.

According to this second alternative of the invention, the process comprises the following steps:

a1/ machining at least one groove in a metal plate;

b1/ filling at least one container with a phase-change material (PCM) of metal alloy or salt type, either by pouring the PCM material in the liquid state or by inserting the PCM material in the solid state;

b2/ placing under vacuum and rendering leaktight the container(s) filled with PCM material;

b3/ fitting the container(s) into the groove(s);

b4/ positioning another metal plate against the machined plate so that at least one groove of the machined plate delimits a portion of a cell containing the container(s) filled with PCM material;

c1/ assembling the metal plates with one another and with the container(s), either by hot isostatic pressing (HIP), or by hot uniaxial pressing (HUP) so as to obtain diffusion welding between the metal plates and container(s), or by brazing, at least one groove of the machined plate assembled with the other plate delimiting a cell containing the container(s) filled with PCM material.

In other words, the process according to this second alternative consists firstly in inserting the phase-change material (PCM) in the solid or liquid state into a container, the shape of which allows the insertion thereof into the cells formed by the assembly of the plates, then in placing this container under vacuum and rendering it leaktight. Here, the steps d/, e/, f/ according to the first alternative are no longer necessary.

Several containers may be used and juxtaposed in the assembly.

This second alternative is advantageous since the filling of the PCM material may be carried out more easily in individual cells than in a complete exchanger module, and the diffusion welding of the container with the exchanger guarantees a better mechanical strength than a direct assembly by melting. The melting of the PCM during the HIP step c1/ is not inconvenient since it remains contained in its container.

It goes without saying that when an exchanger module obtained according to the invention comprises an outer face intended to be subjected to a heat flux originating from the surrounding medium, the flux temperatures may not degrade the welding, the diffusion welding or the brazing. In other words, it is ensured that the operating temperatures of these exchanger modules remain below the melting temperatures of the base materials of the exchanger and of the materials used for the optional welds and brazes.

The assembly by diffusion welding or by brazing according to the invention makes it possible to envisage all sorts of geometries for the fluid channels and also for the cells for containing the PCM material and to include, starting from the phase of machining the groove(s), the vents, the filling nozzles and communications between PCM cells necessary for filling the cells. According to the invention, any type of shape may be obtained for the fluid circuit(s): straight, bent, zig-zag.

The manufacturing process according to the invention is clearly distinguished from the processes for manufacturing heat exchangers incorporating a PCM material according to the prior art, in particular from patent DE102010004358, in that it makes it possible to shape the PCM cells according to any geometry in order to promote reactant mixing and heat exchanges and any dimension on the millimeter or centimeter scale, while being simple to implement and having a lower cost.

The inventors thought of applying the already proven technique for manufacturing plate exchangers which consists of an assembly by diffusion welding or by brazing in order to produce cells for containing a PCM material. Surprisingly, although simple to implement, no one had thought to do it until now. Indeed, assembly by diffusion welding has been used to date for producing parts of great compactness. However, applying this manufacturing technique makes it possible to achieve a porosity, i.e. a ratio between the fluid circulation volume and the total volume of the material that is very high, typically up to 80%. It is possible therefore to obtain a large phase-change material containment volume in the exchanger and therefore to attain good thermal performances and a good compactness. In particular, it is possible within the context of the invention to use a fusible insert to avoid the deformation of the cells during the HIP step c/, which makes it possible to obtain PCM-containing cells of large volume and therefore is highly favorable when the PCM is a good heat conductor (which is the case for a metallic material).

The characteristic dimensions of the cells will be adapted to the thermal power to be exchanged, to the necessary storage capacity and to the mechanical and thermal properties of the materials, they may typically range from 2 mm to 250 mm.

Owing to the process according to the invention, in other words a heat exchanger having at least one fluid circuit and which incorporates a phase-change material PCM is obtained that has a high mechanical strength, a high thermal storage capacity and which enables rapid heating of a heat transfer fluid circulating in the circuit either directly by the heat flux over the dedicated face, or indirectly by recovery of the heat stored by the PCM material in the cells.

According to one preferred variant, the steps a/ to f/ or a1/ to c1/ are carried out so as to create a set of fluid channels defining two separate circuits and a set of cells containing a PCM material.

According to one embodiment variant, the wall of one of the metal plates assembled according to step c/ or c1/ forms a portion of a channel of a fluid circuit of the exchanger.

According to one embodiment variant, step a/ or a1/ is carried out so as to obtain at least one groove that is open at both its ends, the steps b/ and c/ or b4/ and c1/ making it possible to obtain at least one groove of the machined plate assembled with the other plate that delimits a fluid circulation channel that is open at both its ends, the steps d/to f/ not being carried out, so as to leave the fluid circulation channel open at both its ends, said channel forming a channel of a fluid circuit of the exchanger.

According to one advantageous embodiment variant, the other metal plate positioned and assembled according to step b/ and c/ or b4/ and c1/ is also machined with at least one groove that is open at at least one of its ends and that forms a portion of a cell.

Preferably, the steps a/ to f/ or a1/ to c1/ are carried out so as to create a set of fluid channels defining two separate circuits and a set of cells containing a PCM material.

Prior to the hot isostatic pressing (HIP) step c/ or c1/, a preformed tube may advantageously be inserted into each groove, the tube forming a portion of a cell for containing the PCM material or a portion of a channel of a fluid circuit of the exchanger. It is thus possible to carry out the HIP at high pressure in a reliable manner.

Prior to the hot isostatic pressing (HIP) step c/ or c1/, a fusible element may also advantageously be inserted into each groove. The deformations capable of being generated during the HIP are avoided or at the very least limited. The fusible element is either dissolved chemically or discharged by melting.

Preferably, the metal plates are made of carbon steel, stainless steel, or of a nickel-based or titanium-based alloy, step c/ or c1/ being carried out by (HIP) pressing or by (HUP) pressing and step f/ being carried out by welding.

According to one preferred embodiment variant, the cell(s) and where appropriate the fluid circulation channel(s) consist of grooves machined in a ceramic material, such as graphite, silicon carbide (SiC), silicon nitride (Si₃N₄) or a nano-lamellar material (MAX phase), steps c/ or c1/ and f/ being carried out by brazing.

When it is desired to produce a heat exchanger module intended to be in contact with a heat flux originating from a surrounding medium, prior to step c/ or c1/, at least one flat metal plate is positioned against the non-machined face of a grooved metal plate, the face of the other flat metal plate opposite that positioned against a grooved plate forming the outer face of the exchanger module.

The invention also relates, under another of its aspects, to a heat exchanger module comprising at least one fluid circuit comprising at least one fluid circulation channel, at least one cell containing a phase-change material (PCM) of metal alloy or salt type, at least the cell(s) being delimited by walls of at least one first metal plate either welded, or diffusion welded, or brazed to at least one second metal plate, and comprising either a closure plate welded to one and/or the other of the first and second metal plates, and closing each open end of each cell filled with PCM material, or (a) container(s) filled with PCM material contained in the at least one cell.

According to one advantageous embodiment, the module comprises at least one outer face intended to be in contact with a heat flux.

According to one feature, the circuit is of elongated shape along an axis X and the cell(s) is (are) of elongated shape along an axis X1.

Advantageously, each cell has a width or a height, measured transverse to the axis X, of between 2 mm and 250 mm.

According to one embodiment variant, the cell(s) is (are) arranged so that their axis X1 is substantially orthogonal to the axis X of the fluid circulation channel(s).

The invention finally relates to the use of a heat exchanger module described above, wherein the heat exchanges between the heat flux originating from the surrounding medium are carried out at high temperatures.

The applications targeted by an exchanger according to the invention are numerous and relate to the processes in which the heat exchanges are carried out at high temperatures. For the purposes of the invention, the expression “high temperatures” is understood to mean temperatures above 200° C., preferably between 400 and 800° C. One advantageous use of an exchanger module according to the invention is for storing the heat with a view to the later use thereof.

Another advantageous use is for smoothing out the temperature fluctuations of the fluid circuit.

### DETAILED DESCRIPTION

Other advantages and features of the invention will emerge more clearly on reading the detailed description of exemplary embodiments of the invention given by way of illustration and non-limitingly with reference to the following figures, among which:

FIG. 1 is an exploded schematic view of various components of a heat exchanger and of the leaktight container used during a HIP pressing manufacturing process according to the prior art;

FIG. 2 is an exploded schematic view of various components of a heat exchanger and of the leaktight container used during a HIP pressing manufacturing process according to a variant of FIG. 1;

FIG. 3 is a schematic transverse cross-sectional view of a heat exchanger module incorporating a phase-change material PCM according to the invention;

FIG. 4 is an exploded schematic view of various components of an exchanger module according to FIG. 3;

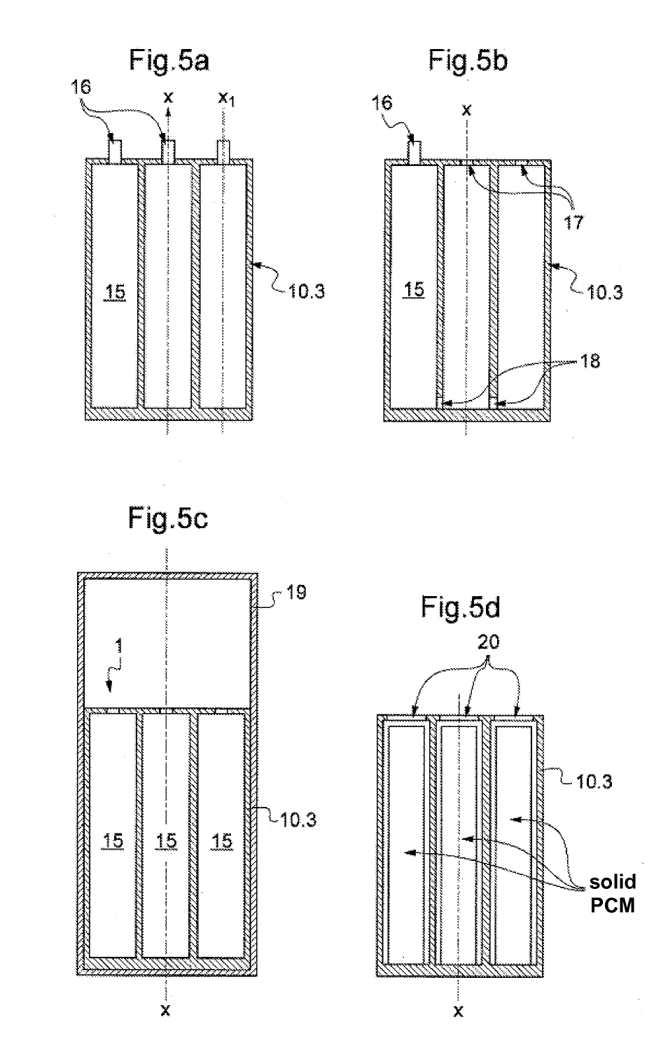

FIGS. 5A to 5D illustrate, in a longitudinal cross-sectional view, various steps of filling the cells of an exchanger module according to the invention with a PCM material;

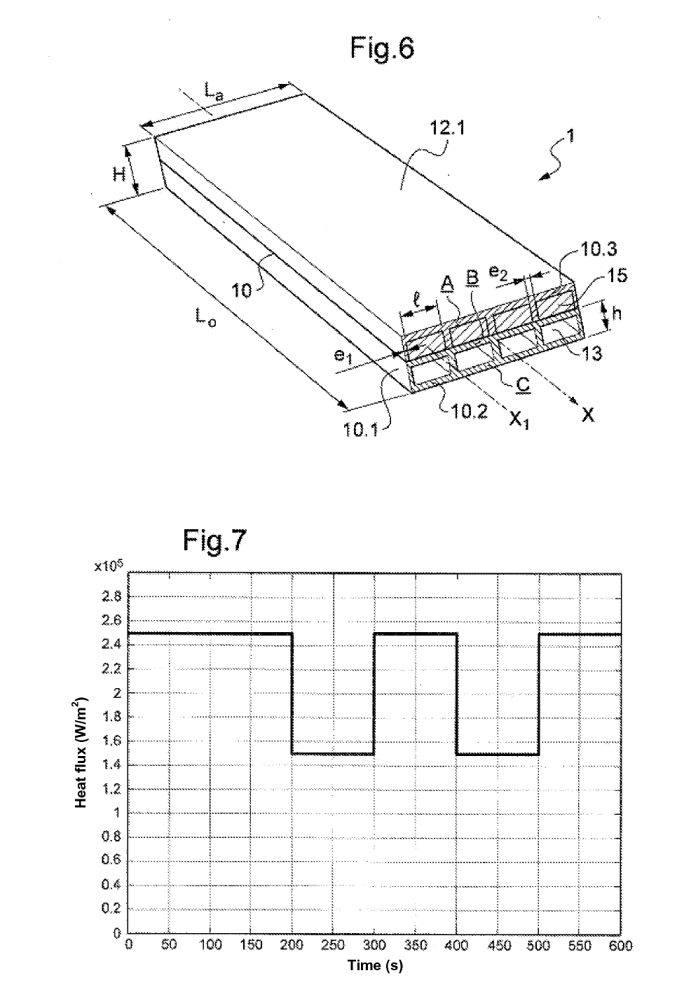

FIG. 6 is a perspective view of a heat exchanger module incorporating a phase-change material PCM according to the invention, on which a numerical simulation of thermal behavior has been carried out;

FIGS. 7 to 9 are curves illustrating the thermal behavior of the heat exchanger module according to FIG. 6;

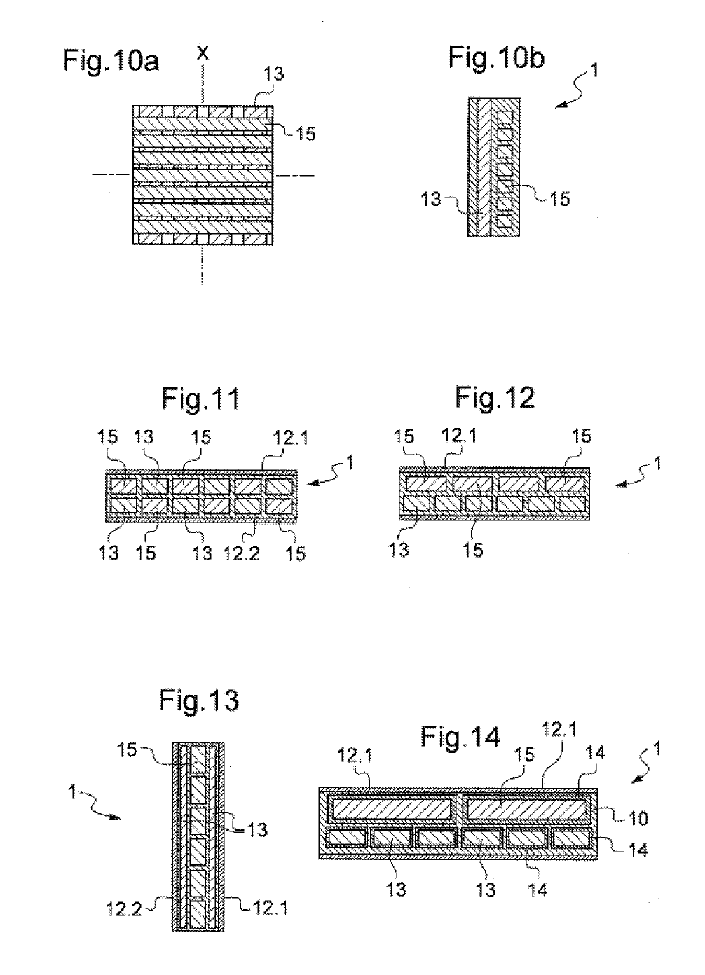

FIGS. 10A and 10B illustrate an embodiment variant of an exchanger module according to which the circulation channels and the cells containing a PCM material are oriented at 90° with respect to one another;

FIGS. 11 to 14 illustrate yet other embodiment variants of an exchanger module;

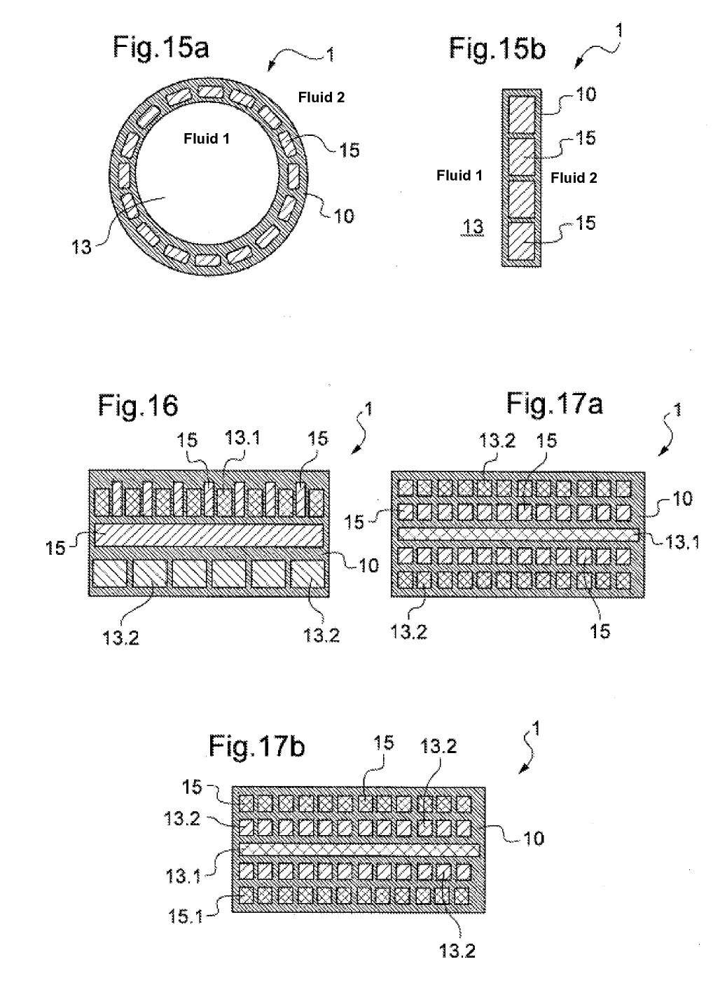

FIGS. 15A and 15B illustrate an embodiment and usage variant of an exchanger module as a wall separating two fluids;

FIG. 16 illustrates an embodiment variant of an exchanger module having two fluid circulation circuits;

FIGS. 17A and 17B illustrate two separate embodiment variants of a heat exchanger module having two fluid circuits, as exchanger-reactor of a chemical reaction.

For the sake of clarity, the same references denoting the same elements of a heat exchanger according to the prior art and of a heat exchanger module incorporating a PCM material according to the invention are used for all the FIGS. 1 to 17B.

It is specified that the various elements, in particular the cells for containing the PCM material and fluid circulation channels according to the invention are represented solely for the sake of clarity and that they are not to scale.

FIGS. 1 and 2 relating to the production of a plate heat exchanger according to the prior art have already been commented upon in the preamble. They are not described here in detail.

A heat exchanger module 1 incorporating a PCM material according to the invention, the plates 10.1, 10.2, 10.3, 12.1, 12.1 of which are welded by hot isostatic pressing (HIP) is shown in FIG. 3. It comprises a row of cells 15 for containing PCM material, each of the cells 15 being above and facing a channel 13 for circulation of a heat transfer fluid. The channels 13 also form a row of channels. The exchanger 1 additionally comprises a face 12.1 arranged above the row of cells 15 incorporating a PCM material, this face 12.1 being intended to receive a high-temperature heat flux.

In order to obtain this heat exchanger module according to the invention, the following steps were carried out.

Step a/: identical grooves of elongated shape are machined in three metal plates 10.1, 10.2, 10.3. The grooves intended to form the containment cells 15 are open at only one of their ends, while those intended to form the fluid circulation channels 13 are open at both their ends. As illustrated in FIG. 4, the grooves may all be identical and for example of rectangular cross section.

Step b/: the machined metal plate 10.2 is positioned against the machined plate 10.1 with their grooves facing individually so that they each delimit a portion of a fluid circulation channel 13. Likewise, the machined metal plate 10.3 is positioned against the plate 10.1 so that each groove of the machined plate 10.3 delimits a portion of a cell for containing a PCM material (FIG. 4). Finally, a solid metal plate 12.1 is positioned against the plate 10.3, this solid plate 12.1 defining the face of the exchanger to be exposed to a high-temperature heat flux. The same thing is done with a metal plate 12.2 against the plate 10.2.

Step c/: the metal plates 10.1, 10.2, 10.3, 12.1, 12.2 are assembled with one another by applying a hot isostatic pressing (HIP) cycle. The HIP cycle applied is advantageously carried out at high temperature, typically at 1000° C. and at high pressure, typically at 1000 bar, for a duration of one to two hours. A diffusion weld is thus obtained between the metal plates, in particular around the edges of the grooves 13, 15.

Step d/: each cell 15 is then filled with a phase-change material (PCM) of metal alloy or salt type.

The filling may be carried out either by pouring the PCM material in the liquid state (FIGS. 5A, 5B, 5C), or by inserting the PCM material in the solid state (FIG. 5D).

Thus, for filling the cells 15 with the PCM material in the liquid state, it is possible to carry out only one gravity pouring of the PCM preheated above its liquidus temperature. The air initially present in the cells 15 then escapes either via the filling channel 16 itself (FIG. 5A), or via a vent 17 made for this purpose at one end of the cells 15 (FIG. 5B). In order to limit oxidation problems, the PCM material in the liquid state is preferably poured under a protective atmosphere or under vacuum. As illustrated in FIG. 5B, a communication may be provided between cells 15 via channels 18 provided for this purpose from the step a/ of machining the grooves.

According to one preferred variant, the heat exchanger module obtained according to step c/ and the PCM material in the solid state are initially placed in a leaktight container 19 (FIG. 5C). The assembly is then degassed in order to reduce the oxygen content. Heating the assembly above the liquidus temperature of the PCM material enables the PCM to flow into the cells 15 (FIG. 5C).

According to another variant, the filling of the cells is carried out by the insertion of cylinders or parallelepipeds of PCM in the solid state into the cells 15 through passages 20 provided for this purpose (FIG. 5D). It is of course ensured that the unit volume of a cylinder or parallelepiped of PCM material is smaller than the unit volume of a cell 15 in order to allow the expansion of the PCM during the melting thereof.

Step e/: at least one other metal plate, referred to as a closure plate, is then positioned against the plates already assembled so as to close each open end of each cell 15 filled with PCM material.

Step f/: finally the closure plate(s) is (are) assembled with the already assembled plates either by welding or by brazing.

In order to validate the possible application of a heat exchanger module incorporating a PCM material that has just been described for processes operating at the high temperatures, a numerical simulation of the thermal behavior was carried out.

The exchanger module 1 which was the subject of the simulation is represented schematically in FIG. 6; it consists of plates 10.1, 10.2, 10.3 of Inconel 600 nickel-based alloy machined so as to form a row of four fluid circulation channels 13 facing a row of four cells 15 containing a PCM material. Each channel 13 has shapes and dimensions identical to each cell 15. A channel 13 has a height h of 5 mm and a width 1 of 10 mm. The total length Lo of the exchanger module is 180 mm, its height H is 16 mm and its width La is 48 mm. The side walls 10 have a thickness e1 of 1 mm, the other walls 10 have a thickness e2 of 2 mm. In the simulation example, all the channels 13 and the cells 15 are elongated along an axis, respectively X1, X2, parallel to the longitudinal axis of the exchanger 1.

Thus, the dimensions used for the various parts of the exchanger result in a porosity (fluid volume/total volume) of 26% and a volume fraction of PCM (PCM volume/total volume) of 26%.

The exchanger is subjected to a heat flux in a cyclical manner over its upper face 12.1 and is cooled by a fluid circulating in the channels 13 at the temperature of 300° C.

The inlet temperature of the fluid, i.e. the temperature at the inlet of the channels 13, is assumed to be constant over time. The heat exchange between the walls of the channels 13 and the fluid is modelled by a constant exchange coefficient of 500 W/m²/K.

The thermal properties of the materials of the plates and of the PCM used for the numerical simulation have been summarised in the table below. The physical properties of the PCM material used are those of an aluminum-silicon (AlSi) alloy. It goes without saying that the AlSi alloy is only cited by way of illustration.

TABLE

| | | | | | Latent |
|---|---|---|---|---|---|
| | Thermal | | Heat | Melting | heat of |
| | conductivity | Density | capacity | point | fusion |
| Material | (W/m/K) | (kg/m³) | (J/kg/K) | (° C.) | (kJ/kg) |
| Inconel | 15 | 7800 | 500 | N/A | N/A |
| PCM | 160 | 2700 | 1400 | 576 | 560 |
| Copper | 400 | 8700 | 385 | N/A | N/A |

The simulation is carried out over a duration of 600 seconds while varying the heat flux applied to the upper face 12.1 from 250 kW/m² to 150 kW/m², as is symbolized by the graph from FIG. 7.

In response to the application of this cyclical heat flux, the variation over time of the outlet temperature of the fluid from the channels 13 is observed.

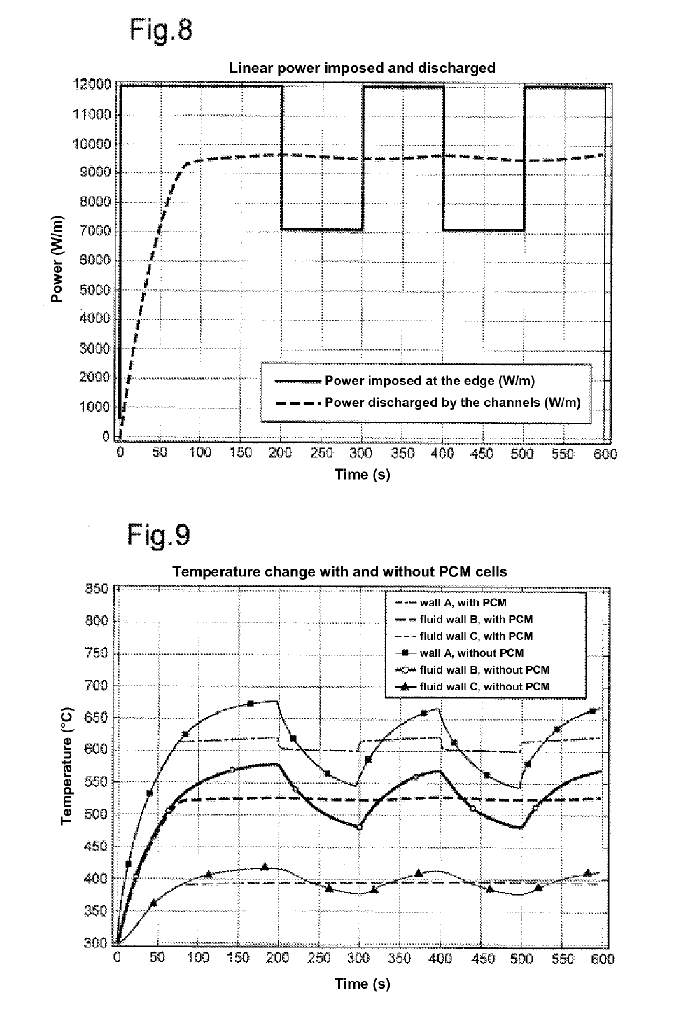

During the start-up of the transient state, the flux applied is 250 kW/m², which results in the melting of the PCM after a time of 70 s approximately (FIG. 8).

During successive cycles, the phase change of the PCM material makes it possible to smooth out the temperature variations in the exchanger and results in a heat flux exchanged with the fluid that is almost constant, as illustrated by the curve with crosses in FIG. 8.

Illustrated in FIG. 9, in the form of curves, is the change in the temperatures of the various walls A, B, C with or without PCM materials according to the invention in the course of the cycles: it is clear from this FIG. 9 that the PCM material in the cells 15 also results in a temperature of wall A, B, C of the channels 13, 15 that is almost constant. It is specified that in this FIG. 9, the cells 15 comprising no PCM material comprise copper instead.

Thus, the energy absorbed or released by the phase change of the material, equal to 300 kJ/m, i.e. 54.4 kJ, compensates for the incident power variation, equal to 240 kJ/m, i.e. 43.2 kJ, at each cycle and the high thermal conductivity of the PCM material, equal to 160 W/m/K, makes it possible to rapidly mobilize all of the material.

As seen in this FIG. 9, the temperature variations at the outer wall A, which are of the order of 125° C. in the case of the exchanger without PCM, are limited to around 20° C. in the case of the exchanger according to the invention incorporating the PCM material. The temperature variations within a fluid circulation channel 13 are themselves 100° C. for cells 15 with copper, while they are less than 5° C. for cells 15 filled with PCM material.

In other words, it may be concluded therefrom, on the basis of this numerical simulation, that an exchanger module according to the invention incorporating a PCM material in its cells 15 has the ability to smooth out the temperature fluctuations of the fluid at the outlet of the channels 13 of the exchanger and thus to provide the components of a system located downstream of the exchanger with stable operating conditions. Such smoothing out makes it possible to limit the problems of thermal fatigue in the exchanger itself and in the components of a system, downstream of the exchanger. In other words, owing to the invention, it is possible to increase the service life of an exchanger module with fluid circulation and also that of components of a downstream component.

In the simulation example that has just been described, the channels 13 and the cells 15 containing the PCM are parallel. As an alternative variant, the fluid 13 circulation channels 13 and the cells 15 containing the PCM material can be produced perpendicularly. Such an alternative variation is illustrated in FIGS. 10A and 10B in which the axes X1 of the cells are at 90° to the longitudinal axis X of the exchanger along which the channels 13 are produced. Such a variant is advantageous since it makes it possible to further improve the mechanical resistance of the exchanger to the stresses induced by the volume changes of the PCM material during the melting/solidification thereof.

According to one embodiment variant, provision may be made to arrange the cells 15 containing the PCMs in staggered rows with respect to the fluid circulation channels 13 in order to further improve the heat exchanges between fluid and PCM material (FIG. 11).

According to one embodiment variant, during step b/ preformed metal tubes 14 of square or rectangular cross section may be inserted individually into the grooves for the channels 13 and the cells 15 (FIGS. 12 to 14). A hot isostatic pressing HIP step c/ is then carried out by applying pressure also to the inside of the tubes. Moreover, only the cells 15 may consist of tubes, the channels 13 then consisting of the grooves, and vice-versa. In the variant illustrated in FIG. 13, it is seen moreover that it is possible to produce fluid channels 13 on either side of a row of cells 15, the channels 13 being close to each face 12.1, 12.2 of the exchanger in contact with the surrounding medium.

In order to delimit the cells 15 or channels 13, it is possible to implant inserts into the grooves during step b/, the role of which inserts is to prevent any significant deformation of the channels or cells during the hot isostatic pressing cycle. The inserts will then be eliminated once the assembly is obtained, either by melting in the case of a material having a melting point below the welding temperature, or by acid attack.

In the case where a PCM material having a high thermal conductivity is selected, for example when it is a question of a metal, it may be advantageous to reduce the dimensions of the cells 15 and to increase the number thereof. The presence of walls of structural material around cells 15 of smaller dimensions gives the exchanger a better mechanical resistance to the stresses induced by the volume changes of the PCM material during the melting/solidification thereof.

One variant may consist in using an exchanger module 1 according to the invention as a wall 10 for separating two fluids at different temperatures in order to smooth out the temperature variations of a system. The shape of the wall 10 may be adapted to the application and may in particular be cylindrical (FIG. 15A) or flat (FIG. 15B) or in any other shape. Such a use as a separating wall 10 may be for example for a fossil fuel or biomass combustion system or for an industrial system that emits a hot gas cyclically.

A heat exchanger module 1 according to the invention may be produced to comprise two separate fluid circulation circuits 13.1, 13.2 in order to smooth out the temperature variations of one of the fluids (FIG. 16).

A heat exchanger module may form an exchanger-reactor comprising a reactant fluid circulation circuit in a single channel 13.1 and a utility fluid circulation circuit in two rows of channels 13.2 on either side of the channel 13.1 (FIGS. 17A and 17B). The cells 15 for containing the PCM material may be inserted between the channels 13.1 and 13.2 (FIG. 17A) or on the outside of the channels 13.2 for circulation of the fluid used (FIG. 17B). In these cases, the PCM material makes it possible to significantly reduce the temperature increase rate of the exchanger-reactor and facilitates the intervention of an operator and/or the response of a controller.

The invention may be applied in one of the forms described to heat storage or to smoothing out temperature fluctuations in order to guarantee the safety or to increase the service life of the components of a system and of the heat exchanger module itself. Mention may be made of the following components, smoothing out the temperature fluctuations of which is particularly advantageous: turbines, Stirling engines, exchangers, etc.

Likewise, mention may be made of a non-exhaustive list of possible applications of an exchanger module according to the invention:
storage of the heat produced by a solar receiver during the day for use in the evening or overnight;
recovery of the heat lost cyclically by an industrial (foundry, steel works) process in order to supply another process;
reduction in the temperature drop of the heat transfer fluid in a concentrating solar power plant during variations in insolation (passage of clouds);
protection of the components of a microelectronic system;
limitation of thermal excursions in the case of exothermic or endothermic reactions within an exchanger-reactor;
stabilization of the temperature in electrochemical cells (electrical batteries, high temperature steam electrolysis (HTSE) cells).
damping temperature oscillations of gases in a fossil fuel or biomass combustion unit.

The invention is not limited to the examples which have just been described; it is possible in particular to combine with them features of the examples illustrated in variants that are not illustrated.

### REFERENCES CITED

[1]: Maruoka N., Sato K., Yagi J, Akiyama T. “Development of PCM for Recovering High Temperature Waste Heat and Utilization for Producing Hydrogen by Reforming Reaction of Methane”, ISIJ International, Vol. 42 (2002), No. 2, pp. 215-219.
[2]: Nomura T. “Technology of Latent Heat Storage for High Temperature Application: A Review”, ISIJ International, Vol. 50 (2010), No 9, pp. 1229-1239.
[3]: Kenisarin M. “High-temperature phase change materials for thermal energy storage”, Renewable and Sustainable Energy Reviews, 14 (2010) pp. 955-970.
[4]: Farid M. M. and al. “A review on phase change energy storage: materials and applications”, Energy Conversion and Management 45 (2004) pp. 1597-1615.
[5]: Liwu Fan, J. M. Khodadadi “Thermal conductivity enhancement of phase change materials for thermal energy storage: A review”, Renewable and Sustainable Energy Reviews, 15 (2011) pp. 24-46.
[6]: Birchenall C. Ernest, Riechman Alan F. “Heat storage in Eutectic Alloys” Metallurgical Transactions, Vol. 11A (1980), pp. 1415-1420.
[7]: Farkas D., Birchenall C. E. “New Eutectic Allots and Their Heats of Transformation”, Metallurgical Transactions Vol 15A (1985), pp 323-327.
[8]: N. Sharifi, Th. L. Bergman, A. Faghri “Enhancement of PCM melting in enclosures with horizontally-finned internal surfaces”, International Journal of Heat and Mass Transfer 54 (2011) pp. 4182-4192.
[9]: Bo M. L. and al. “Research of Steam Boiler Using High Temperature Heat Pipe Based on Metal Phase Change Material”, 2011 International Conference on Computer Distributed Control and Intelligent Environmental Monitoring.
[10]: Guansheng C., Renyuan Z., Feng L., Shidong L., Li Z. “Numerical Simulation and Experimental Research of Heat Charging Process of Cylindrical Units with PCM of Al—Si Alloy”, 2011 International Conference on Engineering Materials, Energy, Management and Control, MEMC 2011.

1. A process for producing a heat exchanger module comprising at least one fluid circuit and comprising at least one fluid circulation channel, at least one cell containing a phase-change material (PCM), wherein each channel is adjacent to at least one cell, the process comprising the following steps:
a/ machining at least one groove in a metal plate, the groove being open at at least one of its ends;
b/ positioning another metal plate against the machined plate so that at least one groove of the machined plate delimits a portion of a cell;
c/ assembling the metal plates with one another, either by hot isostatic pressing (HIP), or by hot uniaxial pressing (HUP) so as to obtain diffusion welding between the metal plates, or by brazing, at least one groove of the machined plate assembled with the other plate delimiting a cell that is open at at least one of its ends;
d/ filling each cell with a phase-change material (PCM) of metal alloy or salt type, either by pouring the PCM material in the liquid state or by inserting the PCM material in the solid state;
e/ positioning another metal plate, referred to as a closure plate, against the already assembled plates so as to close each open end of each cell filled with PCM material;
f/ assembling the closure plate with the already assembled plates either by welding or by brazing.

2. A process for producing a heat exchanger module comprising at least one fluid circuit and comprising at least one fluid circulation channel, at least one cell containing a phase-change material (PCM), wherein each channel is adjacent to at least one cell, the process comprising the following steps:
a1/ machining at least one groove in a metal plate;
b1/ filling at least one container with a phase-change material (PCM) of metal alloy or salt type, either by pouring the PCM material in the liquid state or by inserting the PCM material in the solid state;
b2/ placing under vacuum and rendering leak: tight the container(s) filled with PCM material;
b3/ fitting the container(s) into the groove;
b4/ positioning another metal plate against the machined plate so that at least one groove of the machined plate delimits a portion of a cell containing the container(s) filled with PCM material;
c1/ assembling the metal plates with one another and with the container(s), either by hot isostatic pressing (HIP), or by hot uniaxial pressing (HUP) so as to obtain diffusion welding between the metal plates and container(s), or by brazing, at least one groove of the machined plate assembled with the other plate delimiting a cell containing the container(s) filled with PCM material.

3. The process for producing a heat exchanger module as claimed in claim 1, according to which the wall of one of the metal plates assembled according to step c/ or c1/ forms a portion of a channel of a fluid circuit of the exchanger.

4. The process for producing a heat exchanger module as claimed claim 1, according to which step a/ or a1/ is carried out so as to obtain at least one groove that is open at both its ends, the steps b/ and c/ or b4/ and c1/ making it possible to obtain at least one groove of the machined plate assembled with the other plate that delimits a fluid circulation channel that is open at both its ends, the steps d/ to f/ not being carried out, so as to leave the fluid circulation channel open at both its ends, said channel forming a channel of a fluid circuit of the exchanger.

5. The process for producing a heat exchanger module as claimed in claim 1, according to which the other metal plate positioned and assembled according to step b/ and c/ or b4/ and c1/ is also machined with at least one groove that is open at at least one of its ends and that forms a portion of a cell.

6. The process for producing a heat exchanger module as claimed in claim 1, according to which the steps a/ to f/ or a1/ to c1/ are carried out so as to create a set of fluid channels defining two separate circuits and a set of cells containing a PCM material.

7. The process for producing a heat exchanger module as claimed in claim 1, according to which, prior to the hot isostatic pressing (HIP) step c/ or c1/, a preformed tube is inserted into each groove, the tube forming a portion of a cell for containing the PCM material or a portion of a channel of a fluid circuit of the exchanger.

8. The process for producing a heat exchanger module as claimed in claim 1, according to which, prior to the hot isostatic pressing (HIP) step c/ or c1/, a fusible element is inserted into each groove.

9. The process for producing a heat exchanger module as claimed in claim 1, according to which the metal plates are made of carbon steel, stainless steel, or of a nickel-based or titanium-based alloy, step c/ or c1/ being carried out by (HIP) pressing or by (HUP) pressing and step f/ being carried out by welding.

10. The process for producing a heat exchanger module as claimed in claim 9, according to which the cell(s) and where appropriate the fluid circulation channel(s) consisting of grooves machined in a ceramic material, such as graphite, silicon carbide (SiC), silicon nitride (Si₃N₄) or a nano-lamellar material (MAX phase), steps c/ or c1/ and f/ being carried out by brazing.

11. The process for producing a heat exchanger module as claimed in claim 1, according to which, prior to step c/ or c1/, at least one flat metal plate is positioned against the non-machined face of a grooved metal plate, the face of the other flat metal plate opposite that positioned against a grooved plate forming the outer face of the exchanger module intended to be in contact with a heat flux originating from a surrounding medium.

12. A heat exchanger module comprising at least one fluid circuit comprising at least one fluid circulation channel, at least one cell containing a phase-change material (PCM) of metal alloy or salt type, at least the cell(s) being delimited by walls of at least one first metal plate either welded, or diffusion welded, or brazed to a second metal plate, and comprising either a closure plate welded to one and/or the other of the first and second metal plates, and closing each open end of each cell filled with PCM material, or (a) container(s) filled with PCM material contained in the at least one cell.

13. The heat exchanger module as claimed in claim 12, comprising at least one outer face intended to be in contact with a heat flux originating from a surrounding medium.

14. The heat exchanger module as claimed in claim 12, the circuit being of elongated shape along an axis X and the cell(s) being of elongated shape along an axis X1.

15. The exchanger module as claimed in claim 14, wherein each cell has a width or a height, measured transverse to the axis X, of between 2 mm and 250 mm.

16. The heat exchanger module as claimed in claim 14, wherein the cell(s) is (are) arranged so that their axis X1 is substantially orthogonal to the axis X of the fluid circulation channel(s).

17. The use of a heat exchanger module as claimed in claim 12, wherein the heat exchanges between the heat flux originating from the surrounding medium are carried out at high temperatures.

18. The use as claimed in claim 17, for storing the heat with a view to the later use thereof.

19. The use as claimed in claim 17, for smoothing out the temperature fluctuations of the fluid circuit.
